(19) United States
(12) Patent Application Publication
(10) Pub. No.: US 2025/0315533 A1
(43) Pub. Date: Oct. 9, 2025

(54) Threat Model Generation Systems

(71) Applicant: Capital One Services, LLC, McLean, VA (US)

(72) Inventors: Anthony Glynn, Fairfax, VA (US); Keith Gasser, Woodbridge, VA (US); Michael James Caughey, Chesterfield, VA (US); Jesus Dominguezmiller, Downington, PA (US); Joshua Edwards, Philadelphia, PA (US); Peter Tanski, Marlborough, MA (US); James Harris, McLean, VA (US)

(21) Appl. No.: 18/628,985

(22) Filed: Apr. 8, 2024

(51) Int. Cl. G06F 21/57; G06F 8/65; G06F 8/71

(52) U.S. Cl. CPC G06F 21/577; G06F 8/65; G06F 8/71; G06F 2221/033

(57) ABSTRACT

Aspects described herein may automatically generate threat models using large language model (LLM). A computing device may send, to LLM, one or more software modules associated with a computing system. The computing device may request the LLM to generate a threat model of the computing system. The computing device may receive, from the LLM, a first output based on the first prompt comprising first information for a first version of the threat model and a penetration test script for the computing system. The computing device may input, to the LLM, the result of the penetration test together with the LLM's previous output, to facilitate the LLM to generate a refined version of the threat model.

### FIELD OF USE

Aspects of the disclosure relate generally to cybersecurity. More specifically, aspects of the disclosure may provide for systems and methods for generating a threat model for a computing system.

### BACKGROUND

A computing system may encounter a variety of threats. For example, a malicious actor may attack a computing system with malware to steal sensitive data or cause corruption in the computing system. In another example, an ordinary operation of the computing system may cause system crashes due to software bugs. A threat model that facilitates understanding those potential threats to the computing system is essential for the optimal functioning of the computing system. However, a computing system may comprise hundreds or thousands of software models interacting with each other. Major threats are often overlooked by threat models that are created based on the technician's experience. Systems and methods for generating accurate threat models are needed.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

A computing system may be exposed to various types of threats. For example, a hacker may attack the system using various types of malicious software. The threats may interrupt the proper functioning of the computing system and/or cause system crashes or data loss. Because a computing system may be complicated and/or threats may change over time (e.g., new types of malware may be created every day), even sophisticated engineering teams may encounter difficulties in creating a threat model with a satisfying level of completeness and accuracy. Using machine learning models to identify threats may help with improving the efficiency of analyzing a large number of software modules in the computing system. However, most machine learning models are designed to process figures (e.g., numbers), and therefore may not be suitable for providing a threat model that depicts threats in a way easily understood by engineers. Threat models generated by those machine learning models may not be suitable for providing meaningful instructions to engineers regarding how to fix the computing system. Large learning models (LLMs) may be advantageous in providing text understood by humans, but LLMs are not designed to guarantee the output is accurate. An efficient way to generate threat models that are both accurate and easily understood is needed.

To overcome limitations in the prior art described above, and to overcome other limitations that will be apparent upon reading and understanding the present specification, aspects described herein are directed towards generating a threat model for a computing system. In at least some embodiments, a computing device may send, to a large language model (LLM), one or more software modules associated with a computing system. The computing device may input, to the LLM, a first prompt requesting information for generating a threat model of the computing system. The threat model may be configured to identify one or more threats to the computing system. The computing device may receive, from the LLM, a first output based on the first prompt. The first output may comprise first information for a first version of the threat model and a penetration test script for the computing system. The computing device may generate, based on the first information, the first version of the threat model. The computing device may receive, based on executing the penetration test script, a result of a penetration test. The computing device may input, to the LLM, the first output, the result of the penetration test, and a second prompt requesting second information for generating a second version of the threat model. The computing device may receive, from the LLM, the second information, and generate, based on the second information, the second version of the threat model. The computing device may perform, based on one or more first threats identified by the second version of the threat model, a remedial action.

The computing device may further receive, from a second computing device, update information associated with the computing system. The computing device may input, to the LLM: the second version of the threat model; the update information; and a third prompt requesting third information for generating, based on the update information, a third version of the threat model. The computing device may receive, from the LLM, the third information.

The update information may comprise at least one of: updated software code associated with the one or more software modules; or a new vulnerability detected at the computing system.

The first output may further comprise: a request for first data associated with the computing system; and a source of the first data. The computing device may generate the second version of the threat model by further retrieving, from the source, the first data, and generating, based on the first data, the second version of the threat model.

The computing device may perform the remedial action by at least one of: blocking a version of the one or more software modules; or providing replacement code.

The computing device may further train the LLM using training data comprising: one or more second software modules; and one or more second threats labeled for the one or more second software modules.

The computing device may further receive an indication of a second threat to the computing system. The second threat may not be identified by the second version of the threat model. The computing device may train the LLM by inputting, to the LLM: the indication of the second threat; and the second version of the threat model.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited to the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example of a computing environment in accordance with one or more illustrative aspects discussed herein;

FIG. 3 depicts an example of neural network architecture for a machine learning model according to one or more aspects of the disclosure;

FIG. 4 is a flow diagram of an example method for threat model generation in accordance with one or more illustrative aspects discussed herein;

FIG. 5 is a flow diagram of an example method for threat model generation in accordance with one or more illustrative aspects discussed herein.

### DETAILED DESCRIPTION

In the following description of the various embodiments, reference is made to the accompanying drawings, which form a part hereof, and which are shown by way of illustration of various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

A machine learning model that comprises a large language model and a specific-purpose machine learning model trained to detect threats to a computing system may be used for threat model generation. The machine learning model may receive software modules of a computing system, and output a threat model identifying threats to the software modules in a format easily understood by a human engineer. As described herein, after a preliminary version of the threat model is generated, additional data may be provided to the machine learning model, and the machine learning model may further refine the threat model based on the additional data. The additional data may include, but may not be limited to: a weakness and/or error in the threat model identified by an engineer, a penetration test result of a penetration test conducted to the computing system, an update to the computing system, and/or a new threat identified to a software module similar to the one in the computing system. The preliminary version of the threat model may be refined based on the additional information. The accuracy of the threat model may be improved. Aspects discussed herein may improve the functioning of a computer because an accurate threat model may be generated by a machine learning model (e.g., an LLM) that may not be originally designed to guarantee the accuracy of its output.

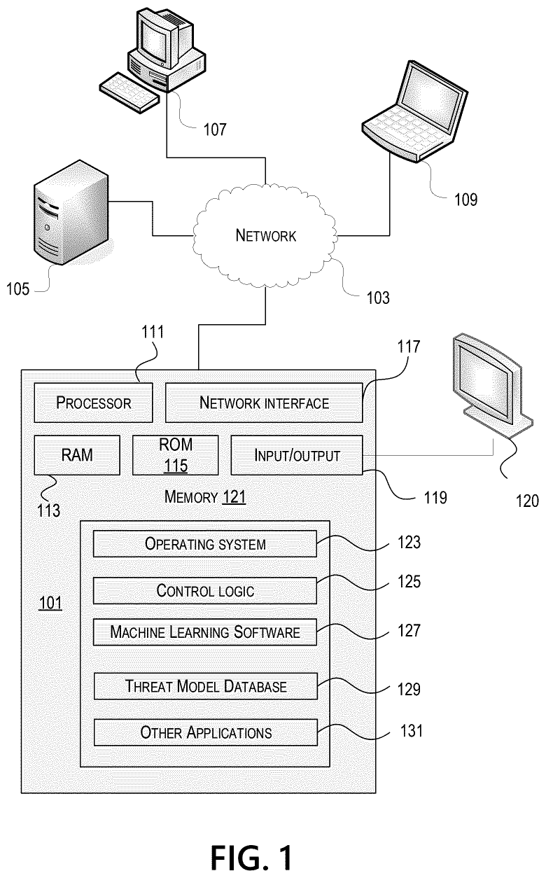

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, machine learning software 127, threat model database 129, and other applications 131 may be stored in a memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

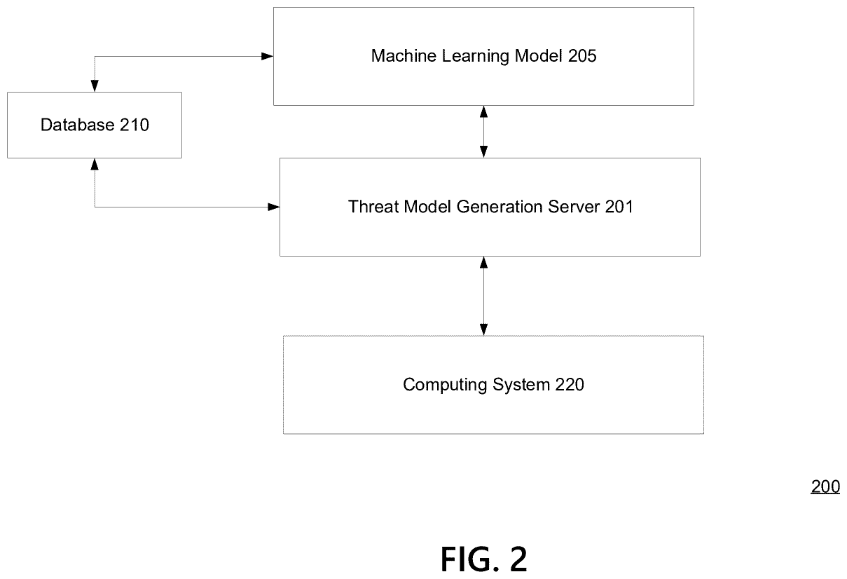

FIG. 2 depicts an illustrative computing environment for generating threat models and/or penetration test scripts in accordance with one or more example embodiments. Referring to FIG. 2, computing environment 200 may include a threat model generation server 201, a machine learning model 205, a database 210, and a computing system 220. Each of a threat model generation server 201, a database 210, and a computing system 220 may be a computing device 101 as described in FIG. 1. The machine learning model 205 may be operated on a computing device 101 as described in FIG. 1. The computing device that executes the machine learning model 205 may be the same physical device as the threat model generation server 201, other computing devices depicted in FIG. 2, or any other computing devices. Each of the threat model generation server 201, the database 210, and the computing system 220 may communicate with other devices via network 103 as described in FIG. 1.

The computing system 220 may comprise one or more computing devices. One or more applications may be executed on the computing system. For example, the computing system may comprise a plurality of computing devices of a financial entity. One or more applications may be executed to facilitate the financial entity to provide services to the client (e.g., storing financial data, authenticating requests, etc.). The one or more applications may comprise one or more operation system applications and/or one or more applications to perform a specific task.

The computing system may be exposed to various types of threats. A threat may be a potential event that may cause malfunctions in the computing system. For example, a threat may be a hacker's attack on the computing system with malicious software. Sensitive data stored in the computing system may be lost. The computing system may be crashed and normal operation may be interrupted. In another example, a threat may be a computing crash triggered by a normal operation due to software bugs in the computing system. To improve the functioning of the computing system, a threat model may be generated by systematically analyzing the computing system and identifying different types of threats to the computing system.

As described herein, a threat model generation system 201 may communicate with the computing system 220, obtain information regarding some or all computing components of the computing systems 220 (e.g., software code of software components, hardware design of hardware components), and generate a threat model by analyzing the components of the computing system 220. For convenience, the discussion herein may use software modules as an example of computing components. It is appreciated that threat models may also be generated for other types of computing components (e.g., hardware components). The threat model generation server 201 may generate the threat model using the machine learning model 205. The machine learning model 205 may be trained to detect threats to one or more computing components. The machine learning model 205 may be trained by training data stored in database 210. The database 210 may comprise information for the computing system, and/or may comprise information external to the computing system. For example, external information may comprise threats that are identified in an external system and/or be provided to the machine learning model via a retrieval-augmented generation (RAG) architecture. The information in the database 210 may be provided before, during, or after user prompts are entered into the machine learning model. Information in the database 210 may be updated from time to time. The machine learning model may be trained by the updated data (e.g., regularly). This may be helpful, for example, to allow the machine learning model to respond to user's prompts by incorporating an up-to-date knowledge base.

The training data may comprise a plurality of software modules and each of the software modules may be labeled. The label may indicate potential threats to the software modules. After a threat model is generated for a computing system, feedback may be received (e.g., whether major threats are omitted from the threat model). The feedback may be further stored in the database 210 and/or used as additional training data to further improve the machine learning model 205.

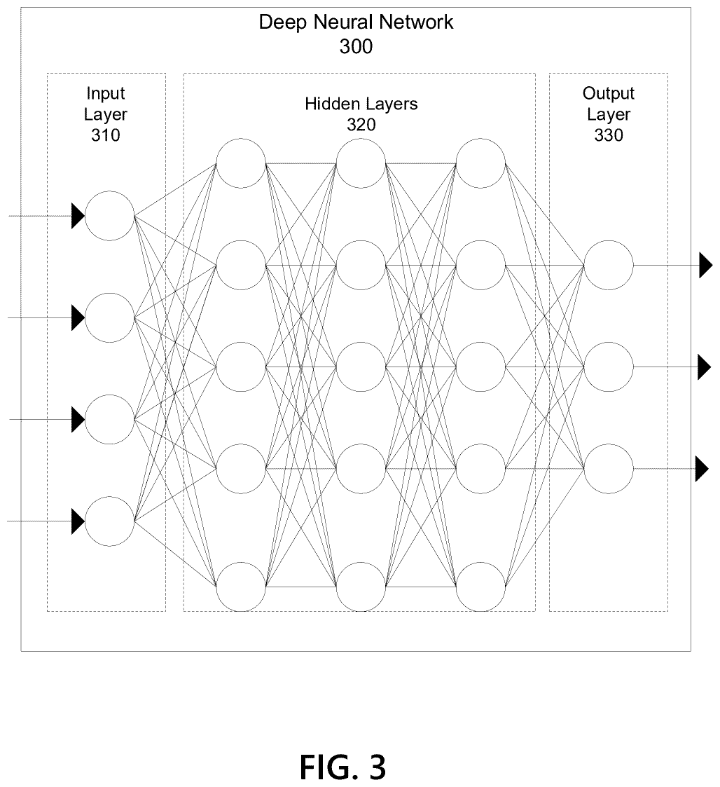

The machine learning model 205 may comprise one or more neural networks discussed described in FIG. 3 below. The machine learning model 205 may comprise a large language model (LLM) that is configured to process and generate human-like text. The LLM may be trained to analyze the software modules, identify threats to the software modules, and/or output information for generating a threat model. Using LLM in the threat modeling process may be helpful, for example, because of the LLM's capability to analyze software code within its related context and its relationship to other portions of the computing system. Using LLM in the threat modeling process may also be helpful, for example, because of the LLM's capability to interact with humans (e.g., engineers who maintain or test the computing system), so that the threat models may be generated into a format that is easily understood by an engineer who tests and/or maintains the computing system.

Using LLM in the threat modeling process may also be helpful, for example, because of the LLM's capability to interact with human engineers. A preliminary version of the threat model may be improved based on a collaboration between the engineers and the LLM. For example, as described in greater detail below, the engineers may conduct a test or a repair to the computing system based on a preliminary threat model, and may easily provide a result of the test or the repair back to the LLM to allow the LLM to further provide an updated version of the threat model based on the new results. Additionally or alternatively, the engineers may identify potential weaknesses (e.g., potential errors or ambiguous) in the preliminary version of the threat model, and/or input additional prompts to the LLM to refine the threat model by resolving the potential weaknesses in the preliminary version. The refining process is particularly helpful because while LLM is advantageous at analyzing and/or integrating a large amount of information and providing creative output based on a large amount of information, the LLM is not particularly advantageous to (e.g., compared with a human engineer) generate an output that is accurate and logically coherent. By the refining process, the accuracy of the threat model may be improved.

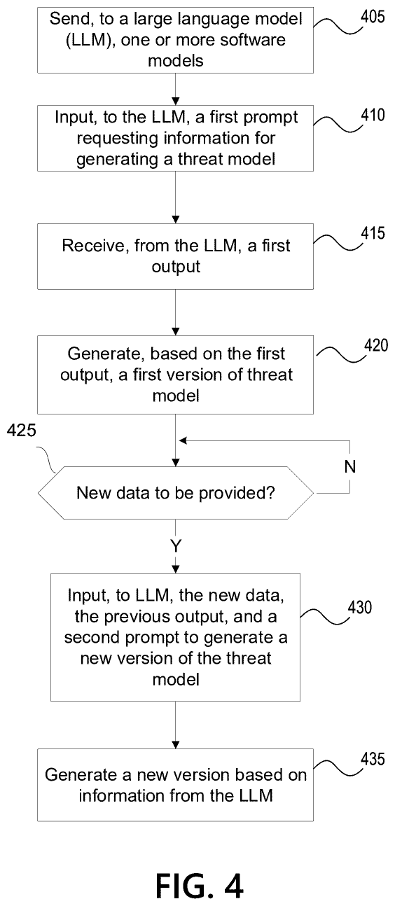

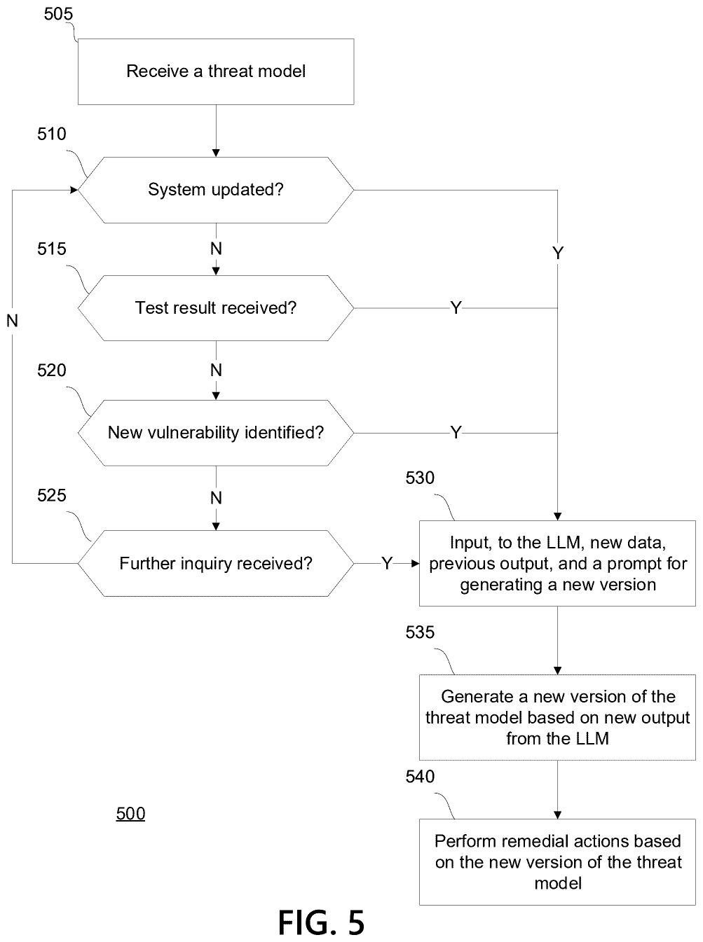

FIG. 3 illustrates an example of machine learning model 300. The machine learning model 300 may comprise one or more neural networks, including but limited to: a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), a consistent adversarial network (CAN) (e.g., a cyclic generative adversarial network (C-GAN), a deep convolutional GAN (DC-GAN), GAN interpolation (GAN-INT), GAN-CLS, a cyclic-CAN (e.g., C-CAN), etc.), or any equivalent thereof. Additionally or alternatively, the machine learning model 300 may comprise one or more decision trees. In some instances, the one or more machine learning model 300 may comprise a Hidden Markov Model. Additionally or alternatively, the machine learning model 300 may comprise one or more large language models (LLMs). Such a machine learning model architecture may be all or portions of the machine learning software 127 shown in FIG. 1. The machine learning model 300 may be all or portions of the machine learning model 205 described in connection with FIG. 2, FIG. 4, and/or FIG. 5. The architecture depicted in FIG. 3 need not be performed on a single computing device, and may be performed by, e.g., a plurality of computers (e.g., one or more of the devices 101, 105, 107, 109). The machine learning model 300 may comprise one or more artificial neural networks. The artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 310, one or more hidden layers 320, and an output layer 330. A deep neural network, as used herein, may be an artificial network that has more than one hidden layer. Illustrated network architecture 300 is depicted with three hidden layers, and thus may be considered a deep neural network. The number of hidden layers employed in deep neural network 300 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The machine learning model 300 may be initialized with a random or white noise set of initial model parameters. The model parameters may then be iteratively adjusted using, for example, stochastic gradient descent algorithms that seek to minimize errors in the model.

FIG. 4 is a flow diagram depicting method 400 for threat model generation in accordance with one or more illustrative aspects discussed herein. The steps in method 400 may be performed by one or more computing devices comprising, for example, the threat model generation server 201 and the machine learning model 205 as shown in FIG. 2.

At step 405, a first computing device (e.g., the threat model generation server 201) may send, to a machine learning model comprising a large language model (LLM), information associated with one or more software modules in a computing system. The software modules may be software modules in various types of applications and interfaces, including but not limited to operating systems (OSs), user applications, application programming interfaces (APIs), integrated development environments (IDEs), or any other types of applications. The first computing device may send some or all the software code of the one or more software modules to the machine learning model. Additionally or alternatively, the first computing device may send a description of the software modules (e.g., functions, sample input/output, database the software modules access to, the technical standard that software modules conform to, etc.) to the machine learning model.

The machine learning model may be the machine learning model 205 as described in connection with FIG. 2. The machine learning model may integrate an LLM and a specific-purpose machine learning model that is trained to detect threats to a software module. Additionally or alternatively, the LLM may be directly trained to identify threats to a software module and/or output information for a threat model. For convenience, the below discussion uses the example in which the LLM is trained to identify threats, output information for a threat model, and/or perform other steps as described herein. It is appreciated that the LLM may be integrated into one or more additional machine learning models to perform the steps described below.

The LLM may be trained, using training data (e.g., training data stored in database 210), to provide information for generating threat models. For example, the LLM may be trained using training data comprising one or more second software modules. One or more second software modules may be labeled. One or more threats to the one or more second software modules may be identified by the label.

As described above, a threat may be an event that causes malfunctions in the computing system due to a weakness or vulnerability in the computing system. For example, a threat may be a hacker attack that is targeted to a vulnerability in the computing system. The LLM may be trained to identify a threat and output information associated with the threat, for example, including but not limited to: the portion of the software module that creates vulnerability, a reason why the portion is vulnerable (e.g., the type of attack that may utilize the vulnerability), and/or a potential remedial action (e.g., replacement code that may fix the vulnerability). The LLM may output the information, which may be used to generate a threat model.

At step 410, the first computing device may input, to the LLM, a first prompt requesting information for generating a threat model for the computing system. The threat model may be configured to identify one or more threats to the computing system. The first prompt may identify the format in which the requested information is to be conformed with. The first prompt may comprise the security standard (e.g., an open web application security project (OWASP) standard) that the computing system should conform to (non-conformance may create a weakness and/or introduce a threat).

For example, the first computing device may input a first prompt to the LLM as: “Based on the OWASP standards, please identify what insecurities might be present in an API with this schema.” The first computing device may also send the API with the scheme referred to in the first prompt. The first computing device may send a description to the API, to the LLM. For example, the API and the description the first computing device sends to the LLM may be as below:

| POST | | |
|---|---|---|
| /my/api/call | | |
| Function: Performs actions such as saving new updates. | | |
| Parameters (Name, Description, Default Value) | | |
| User-Id, “This is the field where the person calling the API | | |
| tells you how to look up the user in a database”, null | | |
| Favorite-Sport, “This is the field for providing which sport | | |
| a user prefers. Valid options are basketball, baseball, | | |
| volleyball, soccer, and wrestling”, wrestling | | |
| Example Value | | |
| { | | |
| “User-Id”: “12345”, | | |
| “Favorite-Sport”: “basketball” | | |
| } | | |
| Accept-Language: | | |
| Available values : en-US, es-US, en-CA, fr-CA | | |
| Default value : en-US | | |
| Responses: | | |
| Response content type: application/json | | |
| Code, Description | | |
| 201, User stored successfully | | |
| 400, Client error. Possible error codes are: | | |
| ID | Description | Developer text |
| 40001 | Sport is invalid. | A sport was selected that was not valid |
| 4008 | Invalid db | You need to look up the Oracle |
| | credentials | credentials in the Database, |
| | | using ID 1234 |

The LLM may receive the first prompt and/or information associated with the API. The LLM may identify the threats in the API based on the first prompt. The first prompt may also specify the format of the expected output from the LLM. For example, the first prompt may state: “Please provide a response that includes a subset of the code provided, or an answer of ‘nothing insecure’ if nothing is found to be insecure.”

At step 415, the first computing device may receive, from the LLM, a first output. The first output may be generated by the LLM based on the first prompt. The first output may comprise the first information for the first version of the threat model. For example, the first information may indicate one or more threats identified for the one or more software modules. The first output may be in a format stipulated by the first prompt.

Consistent with the example described in step 410 above, in which the API schema and the corresponding first prompt are provided, the first computing device may receive the first information as below:
Error 40008 and its description “Invalid db credentials. You need to look up the Oracle credentials in the Database, using ID 1234” is problematic, as the description provides information to a potential malicious actor that gives ID information, as well as information about the underlying architecture of the system.

The first information may also comprise other information associated with the identified threat. For example, the first information may comprise a risk assessment indicating the potential impact of each of the identified threats, a likelihood regarding how probable each the threats may occur, and/or a recommendation of a remedial action. It is appreciated that the information for generating the threat model is merely an example, other information relevant to threat modeling is possible.

The first output may also comprise a request for additional data. The additional data may be requested by the LLM to further improve the threat model. For example, the additional data may comprise information related to another portion of the computing system that interacts with the one or more software modules analyzed by the LLM. For example, if the one or more software modules analyzed by the LLM retrieve data from a database, the LLM may request information associated with the database in order to further identify potential threats. In another example, the additional data may comprise a result of a penetration test on the one or more software modules. The penetration test may simulate a cyber-attack against the computing system to further determine the vulnerabilities of the computing system. The LLM may generate the test instruction (e.g., the scope of the test, the payload of the simulated attack, etc.) and/or send the test instruction to the first computing device. The first computing device may conduct the test (e.g., either directly or via another computing device that communicates with the computing system) and obtain a test result (e.g., logs that reflect the computing system's reaction to the simulated attack). As described in further detail below, the test result may be used to improve the threat modeling (e.g., by generating a refined version of the threat model).

Additionally or alternatively, the test result (e.g., pen-testing findings) may be used to further train the machine learning model. For example, if a potential threat is identified in the penetration test, the machine learning model may be trained to identify similar threats in similar computing systems. For example, different computing systems of the same organization may share a certain level of similarities and may be vulnerable to similar types of threats. The machine learning model that is further trained may be capable of identifying similar threats in similar computing systems (e.g., without requesting a similar penetration test on the other systems).

It is appreciated that the additional data described herein are only examples, and other additional data may also be requested. Additionally or alternatively, the first computing device may obtain additional data with or without an explicit request from the LLM. For example, as described in FIG. 5 below, the computing system or an engineer reviewing the threat model may provide additional data to be sent to the LLM.

At step 420, the first computing device (or the LLM) may generate a first version of the threat model based on the first information for generating the threat model. The first version of the threat model may be a preliminary version of the threat model. The first computing device may generate a version of a threat model by combining the threats identified by the LLM and additional information associated with the computing system that may facilitate an evaluation team to understand the threats. For example, the threat model may comprise an overview of the computing system. Additionally or alternatively, a complete version of the threat model may be generated by the LLM and forwarded to the first computing device.

At step 425, the first computing device may determine whether additional data is to be provided to the LLM. The additional data may be used to improve the threat model. The additional data may be the data requested by the LLM (e.g., as described in step 420 above). Additionally or alternatively, the additional data may be obtained without the explicit request from the LLM. For example, the additional data may comprise a weakness in the threat model that is identified by an engineer reviewing the threat model, an update to the computing system, and/or a new threat identified to a software module similar to the one in the computing system, as described in greater detail in FIG. 5 below. If the first computing device determines that no additional data is to be provided to the LLM, the first computing device may wait until new data is received. If the first computing device determines that additional data is to be provided to the LLM, the method may proceed to step 430.

At step 430, the first computing device may further input, to the LLM, the new data. The first computing device may also input the previous output received from the LLM, so that the LLM may refine the LLM's previous output in view of the new data. The first computing device may input a second prompt requesting second information for generating a new version (e.g., a second version) of the threat model. The new version of the threat model may be a refined version based on the previous version (e.g., the preliminary version). For example, in the previous output, the LLM may identify a potential threat without identifying the precise impact of the threat on the computing system. The LLM may request a penetration test to determine what impact the potential threat may have on the computing system. The first computing device may input the test result (e.g., a test log) to the LLM. The LLM may refine the previous output by providing a precise assessment regarding the impact of the potential threat and/or a priority of fixing the potential threat (e.g., a higher priority may be determined if the impact is likely to be greater), for example, based on the test result.

At step 435, the first computing device may receive, from the LLM, information for generating a new version of the threat model. The first computing device may generate a new version of the threat model based on the information, for example, in a way similar to as described in step 420 above. It is appreciated that the LLM may further request additional data, and/or the first computing device may further obtain additional data and/or provide the additional data to the LLM to generate a newer version. The LLM may generate a newer output accordingly. If no additional data is received for a time period (e.g., a time period exceeding a threshold), the current version of the threat model may be used to update (e.g., fix weaknesses in) the computing system.

The first computing device may receive feedback (e.g., from the computing system) regarding whether the threat model accurately identifies potential threats to the computing system. The feedback may be used as training data to improve the LLM. For example, if the feedback indicates a threat to the computing system is omitted by the newest version of the threat model (e.g., because an actual attack occurs), the computing system may send (e.g., report) the unidentified threat to the first computing device. The threat may be used to train the LLM so that the LLM may be better able to identify similar threats to similar software components in the future.

The steps of method 400 may be modified, omitted, or performed in other orders, or other steps added as appropriate.

FIG. 5 is a flow diagram depicting method 500 for threat model generation in accordance with one or more illustrative aspects discussed herein. The steps in method 500 may be performed by one or more computing devices comprising, for example, threat model generation server 201 and machine learning model 205 as may be shown in FIG. 2. The method 500 may be used in connection with the method 400 as described in FIG. 4. For example, the threat model described in step 505 may be the first version of the threat model as described in step 420 in FIG. 4. In another example, data obtained at steps 510 to 525 may be the additional data as described at step 425 in FIG. 4, for generating a newer version of the threat model.

At step 505, a first computing device (e.g., the threat model generation server 201) may receive a threat model. The threat model may be either a preliminary version of a threat model as described in step 415 or a newer version of the threat model as described in step 435.

At step 510, the first computing device may determine whether an update of the computing system has been made since the current version of the threat model was generated. For example, a software module in the computing system may be updated. Such updates may introduce new threats to the computing system. A refined version of the threat model may be generated after analyzing the weaknesses introduced by the updated software module. If any update is made, the method may proceed to step 530. If no update is made, the method may proceed to step 515.

At step 515, the first computing device may determine whether a penetration test has been conducted on the computing system since the current version of the threat model was generated. The penetration test may be requested by the LLM in a previous output (e.g., as described in step 425 of FIG. 4), or the penetration test may be conducted independently. If the test result of the penetration test is obtained, the method may proceed to step 530. If no penetration test was conducted, the method may proceed to step 520.

At step 520, the first computing device may determine whether a new vulnerability, associated with the computing system, has been identified since the current version of the threat model was generated. The new vulnerability may be identified in the computing system, or the new vulnerability may be identified in a different computing system having similar software modules to the computing system that the threat model depicts. If any new vulnerability is detected, the method may proceed to step 530. If no new vulnerability is detected, the method may proceed to step 525.

At step 525, the first computing device may determine whether any further inquiry regarding the current version of the threat model has been received since the current version of the threat model was generated. For example, the further inquiry may be received from an engineer reviewing the current version of the threat model. For example, the further inquiry may request a clarification of an identified threat (e.g., providing a reason regarding why the software modules may be exposed to the threat). Additionally or alternatively, the further inquiry may identify a potential weakness in the threat model. For example, the current version of the threat model may identify a particular portion of the software module that may be exposed to a potential threat. The engineer may input an inquiry that challenges the conclusion. For example, the engineer may input “I believe the particular portion of the software module you identified operates in a different way from what you described and therefore will not be exposed to the threat you identified,” together with a description of how the particular portion would operate. The further inquiry may be configured to allow the LLM to determine whether the previously identified threat is accurate or not.

If any further inquiry is detected, the method may proceed to step 530. If no further inquiry is detected, the method may proceed back to step 510 and wait for new data to be received.

At step 530, the first computing device may input, to the LLM, new data obtained at steps 510 to 525. For example, if one or more software modules have been updated, the first computing device may input the updated code and/or a description of the updated architecture to the LLM. If a penetration test result is received, the first computing device may input the test result to the LLM. If a new vulnerability is identified (e.g., in another computing system having a similar software module), the first computing device may input the description of the new vulnerability to the LLM. If a further inquiry is received, the first computing device may input the further inquiry to the LLM. The first computing device may also input the previous output received from the LLM, and/or a second prompt requesting second information for generating a second version of the threat model. The previous output and the second prompt may be inputted to the LLM in a way similar to as described in step 430 of FIG. 4.

At step 535, the first computing device may generate a new version of the threat model. The new version of the threat model may be based on new output from the LLM. The new version may be generated in a way similar to as described in step 435.

At step 540, the first computing device may perform, based on one or more first threats identified by the new version of the threat model, a remedial action. For example, the remedial action may comprise blocking a version of the one or more software modules. In another example, the remedial action may comprise providing replacement code to the software component that introduces a threat. After taking the remedial action, if any of the software components in the computing system is updated, the updated software components may be treated as the system updates as described in connection with step 510, and/or may be input to the LLM for generating another new version of the threat model.

The steps of method 500 may be modified, omitted, or performed in other orders, or other steps added as appropriate.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Accordingly, the scope of the invention should be determined not by the embodiments illustrated, but by the appended claims and their equivalents.

What is claimed is:

1. A method comprising:
sending, by a computing device and to a large language model (LLM), one or more software modules associated with a computing system;
inputting, to the LLM, a first prompt requesting information for generating a threat model of the computing system, wherein the threat model is configured to identify one or more threats to the computing system;
receiving, from the LLM, a first output based on the first prompt, wherein the first output comprises:
first information for a first version of the threat model; and
a penetration test script for the computing system;
generating, based on the first information, the first version of the threat model;
receiving, based on executing the penetration test script, a result of a penetration test;
inputting, to the LLM:
an indication of the first output;
the result of the penetration test; and
a second prompt requesting second information for generating a second version of the threat model;
receiving, from the LLM, the second information;
generating, based on the second information, the second version of the threat model; and
performing, based on one or more first threats identified by the second version of the threat model, a remedial action.

2. The method of claim 1, further comprising:
receiving, from a second computing device, update information associated with the computing system;
inputting, to the LLM:
the second version of the threat model;
the update information; and
a third prompt requesting third information for generating, based on the update information, a third version of the threat model; and
receiving, from the LLM, the third information.

3. The method of claim 2, wherein the update information comprises at least one of:
updated software code associated with the one or more software modules; or
a new vulnerability detected at the computing system.

4. The method of claim 1, wherein the first output further comprises:
a request for first data associated with the computing system; and
a source of the first data; and
wherein the generating the second version of the threat model further comprises:
retrieving, from the source, the first data; and
generating, based on the first data, the second version of the threat model.

5. The method of claim 1, wherein the performing the remedial action comprises at least one of:
blocking deployment of a version of the one or more software modules; or
providing replacement code.

6. The method of claim 1, further comprising training the LLM using training data comprising:
one or more second software modules; and
one or more second threats labeled for the one or more second software modules.

7. The method of claim 1, further comprising:
receiving an indication of a second threat to the computing system, wherein the second threat is not identified by the second version of the threat model; and
training the LLM by inputting, to the LLM:
the indication of the second threat; and
the second version of the threat model.

8. A computing device comprising:
one or more processors; and
memory storing instructions that, when executed by the one or more processors, cause performance of actions comprising:
sending, to a large language model (LLM), one or more software modules associated with a computing system;
inputting, to the LLM, a first prompt requesting information for generating a threat model of the computing system, wherein the threat model is configured to identify one or more threats to the computing system;
receiving, from the LLM, a first output based on the first prompt, wherein the first output comprises:
first information for a first version of the threat model; and
a penetration test script for the computing system;
generating, based on the first information, the first version of the threat model;
receiving, based on executing the penetration test script, a result of a penetration test;
inputting, to the LLM:
an indication of the first output;
the result of the penetration test; and
a second prompt requesting second information for generating a second version of the threat model;
receiving, from the LLM, the second information;
generating, based on the second information, the second version of the threat model; and
performing, based on one or more first threats identified by the second version of the threat model, a remedial action.

9. A computing device of claim 8, wherein the instructions, when executed by the one or more processors, further cause performance of actions comprising:
receiving, from a second computing device, update information associated with the computing system;
inputting, to the LLM:
the second version of the threat model;
the update information; and
a third prompt requesting third information for generating, based on the update information, a third version of the threat model; and
receiving, from the LLM, the third information.

10. The computing device of claim 9, wherein the update information comprises at least one of:
updated software code associated with the one or more software modules; or
a new vulnerability detected at the computing system.

11. The computing device of claim 8, the first output further comprises:
a request for first data associated with the computing system; and
a source of the first data; and
wherein the instructions, when executed by the one or more processors, further cause generating the second version of the threat model by cause performance of actions comprising:
retrieving, from the source, the first data; and
generating, based on the first data, the second version of the threat model.

12. The computing device of claim 8, wherein the instructions, when executed by the one or more processors, further cause performing the remedial action by cause performance of actions comprising at least one of:
blocking deployment of a version of the one or more software modules; or
providing replacement code.

13. The computing device of claim 8, wherein the instructions, when executed by the one or more processors, further cause training the LLM using training data comprising:
one or more second software modules; and
one or more second threats labeled for the one or more second software modules.

14. The computing device of claim 8, wherein the instructions, when executed by the one or more processors, further cause performance of actions comprising:
receiving an indication of a second threat to the computing system, wherein the second threat is not identified by the second version of the threat model; and
training the LLM by inputting, to the LLM:
the indication of the second threat; and
the second version of the threat model.

15. A non-transitory computer-readable medium storing computer instructions that, when executed by one or more processors, cause performance of actions comprising:
sending, to a large language model (LLM), one or more software modules associated with a computing system;
inputting, to the LLM, a first prompt requesting information for generating a threat model of the computing system, wherein the threat model is configured to identify one or more threats to the computing system;
receiving, from the LLM, a first output based on the first prompt, wherein the first output comprises:
first information for a first version of the threat model; and
a penetration test script for the computing system;
generating, based on the first information, the first version of the threat model;
receiving, based on executing the penetration test script, a result of a penetration test;
inputting, to the LLM:
an indication of the first output;
the result of the penetration test; and
a second prompt requesting second information for generating a second version of the threat model;
receiving, from the LLM, the second information;
generating, based on the second information, the second version of the threat model; and
performing, based on one or more first threats identified by the second version of the threat model, a remedial action.

16. The non-transitory computer-readable medium storing computer instructions of claim 15, when executed by the one or more processors, further cause performance of actions comprising:
receiving, from a second computing device, update information associated with the computing system;
inputting, to the LLM:
the second version of the threat model;
the update information; and
a third prompt requesting third information for generating, based on the update information, a third version of the threat model; and
receiving, from the LLM, the third information.

17. The non-transitory computer-readable medium storing computer instructions of claim 16, wherein the update information comprises at least one of:
updated software code associated with the one or more software modules; or
a new vulnerability detected at the computing system.

18. The non-transitory computer-readable medium storing computer instructions of claim 15, the first output further comprises:
a request for first data associated with the computing system; and
a source of the first data; and
wherein the instructions, when executed by the one or more processors, further cause generating the second version of the threat model by cause performance of actions comprising:
retrieving, from the source, the first data; and
generating, based on the first data, the second version of the threat model.

19. The non-transitory computer-readable medium storing computer instructions of claim 15, when executed by the one or more processors, further cause performing the remedial action by cause performance of actions comprising at least one of:
blocking deployment of a version of the one or more software modules; or
providing replacement code.

20. The non-transitory computer-readable medium storing computer instructions of claim 15, wherein the instructions, when executed by the one or more processors, further cause training the LLM using training data comprising:
one or more second software modules; and
one or more second threats labeled for the one or more second software modules.
